(19) United States
(12) Patent Application Publication
(10) Pub. No.: US 2010/0323535 A1
(43) Pub. Date: Dec. 23, 2010

(54) System and Apparatus for Reducing Crosstalk

(75) Inventor: Stephen J. Brolin, Livingston, NJ (US)

Correspondence Address: BAKER BOTTS L.L.P., 2001 ROSS AVENUE, SUITE 600, DALLAS, TX, 75201-2980, US

(73) Assignee: Fujitsu Network Communications, Inc., Richardson, TX (US)

(21) Appl. No.: 12/489,058

(22) Filed: Jun. 22, 2009

(51) Int. Cl. H01R 12/00

(52) U.S. Cl. 439/62; 439/941

(57) ABSTRACT

An electrical system includes a backplane, a first electrical component, and a second electrical component. The backplane includes a first column of connectors, a second column of connectors, a third column of connectors, and a fourth column of connectors. The backplane also includes a first plurality of conductive paths that couple the connectors in the first column to an alternating sequence of connectors in the third column and the fourth column. Additionally, the backplane includes a second plurality of conductive paths that couple the connectors in the second column to an alternating sequence of connectors in the fourth column and the third column. The first electrical component couples to the backplane through the first column and the second column. The second electrical component couples to the backplane through the third column and the fourth column.

### TECHNICAL FIELD OF THE INVENTION

This invention relates generally to electronic circuits, and more particularly, to a system and apparatus for reducing far-end crosstalk on tandem connectors of a backplane.

### BACKGROUND OF THE INVENTION

As computing electronics become more dense, the ability to greatly increase the throughput or capacity of a system is expanding. However, the size of connectors or interfaces to those systems is generally constrained. To keep pace with the increasing density of components while minimizing the space occupied by interfaces, a backplane may be utilized and configured to accept modular circuit board panels that allow a user to put in only the components and connectors needed. Additionally, a midplane may be utilized to extend the functional capacity of a given backplane. An I/O panel configured with only the desired interfaces may be connected to a midplane, which provides extensible and flexible connectivity to the backplane. As a result, the spatial utilization of interfaces and connectors can keep pace with electronic capacity and throughput.

Coinciding with the rapid increase in the density of electronics, the available bandwidth of computing systems continues to increase. As signal speed increases, however, crosstalk becomes more severe. Far-end crosstalk degrades signal quality and the overall reliability of the system, especially in systems utilizing tandem connectors in a backplane/midplane configuration. Thus, maintaining signal integrity in systems with high port density using I/O panels may be difficult.

### SUMMARY OF THE INVENTION

The present invention provides a method and system for reducing far-end crosstalk associated with electrical components connected to a backplane and midplane that substantially reduces or eliminates at least some of the disadvantages and problems associated with previous methods and systems.

In accordance with one embodiment of the present invention, an electrical system includes a backplane, a first electrical component, and a second electrical component. The backplane includes a first column of connectors, a second column of connectors, a third column of connectors, and a fourth column of connectors. The backplane also includes a first plurality of conductive paths that couple the connectors in the first column to an alternating sequence of connectors in the third column and the fourth column. Additionally, the backplane includes a second plurality of conductive paths that couple the connectors in the second column to an alternating sequence of connectors in the fourth column and the third column. The first electrical component couples to the backplane through the first column and the second column. The second electrical component couples to the backplane through the third column and the fourth column.

In accordance with one embodiment of the present invention, an apparatus for coupling electrical components includes a backplane interface and a midplane interface. The backplane interface includes a first column of connectors and a second column of connectors. The midplane interface includes a third column of connectors; and a fourth column of connectors. Additionally, the apparatus includes a first plurality of conductive paths that couple the connectors in the first column to an alternating sequence of connectors in the third column and the fourth column. The apparatus also includes a second plurality of conductive paths that couple the connectors in the second column to an alternating sequence of connectors in the fourth column and the third column.

Important technical advantages of certain aspects of the present invention include reducing or eliminating far-end crosstalk associated with signals between electrical components connected to a backplane or midplane. Particular embodiments may also reduce or eliminate near end crosstalk associated with signals between electrical components connected to a backplane or midplane. Additional technical advantages of certain embodiments of the present invention provide circuit card and I/O panel flexibility and extensibility without sacrificing signal quality in high-bandwidth computing systems. Other technical advantages of the present invention will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIGS. 1A and 1B are a perspective and rear view, respectively, of a particular embodiment of a system for reducing far-end crosstalk on tandem connections to a backplane;

FIG. 2 is a logical wiring diagram illustrating in more detail connections between a circuit card and an I/O panel through a backplane that may be utilized in the system of FIGS. 1A and 1B; and

FIGS. 3A and 3B are a front and perspective view, respectively, of an alternative embodiment of the system shown in FIGS. 1A and 1B.

### DETAILED DESCRIPTION OF THE INVENTION

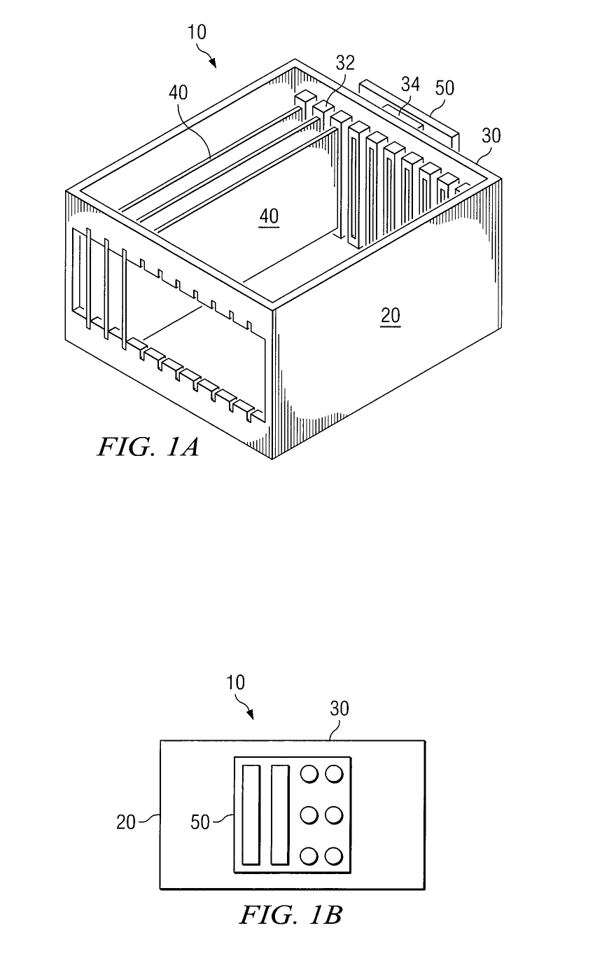

FIGS. 1A and 1B illustrate a perspective and rear view, respectively, of a particular embodiment of a system 10 for reducing far-end crosstalk associated with electrical components coupled to a backplane 30. System 10 includes a housing 20, a backplane 30, a circuit card 40, and an I/O panel 50. Backplane 30 includes one or more backplane interfaces 32 that can each accept a circuit card 40 and one or more midplane interfaces 34 that can each accept an I/O panel 50. To facilitate the reduction or cancellation of far-end crosstalk associated with differential signal pairs transmitted through backplane interfaces 32 and midplane interfaces 34, backplane 30 is wired so that the polarity of certain signal pairs received by backplane interfaces 32 are reversed relative to adjacent signal pairs as they are transmitted through backplane 30 to midplane interfaces 34. By alternately reversing the polarity of adjacent differential signal pairs, far-end crosstalk may be substantially reduced or eliminated.

Housing 20 encloses certain components of system 10 in whole or in part. In particular embodiments, housing 20 may enclose backplane 30. Housing 20 may also enclose one or more circuit cards 40 that attach to backplane 30 through backplane interfaces 32. Additionally, although FIGS. 1A and 1B show an embodiment of system 10 in which I/O panel 50 connects to backplane 30 from outside housing 20, I/O panel 50 may, in particular embodiments, be housed in housing 20. For the purposes of this description, housing 20 may “enclose” a particular backplane 30, circuit card 40, or I/O panel 50 by forming a surface that entirely surrounds the relevant component or one that partially surrounds a portion of the relevant component. As a result, in particular embodiments, elements of system 10 enclosed by housing 20 may have one or more of their surfaces exposed by housing 20. Housing 20 may be composed of metal, plastic, or any other appropriate material. Additionally, housing may be shaped in any appropriate form or manner.

Backplane 30 is a substrate including electrical contacts and electrical circuitry that receives one or more circuit cards 40 through backplane interfaces 32 and that receives one or more I/O panels 50 through midplane interfaces 34. Backplane wiring provides electrical connectivity between backplane interfaces 32 that receive circuit cards 40 and midplane interfaces 34 that receive I/O panels 50. In particular embodiments, backplane 30 may be a printed circuit board positioned on the rear interior surface of housing 20. In general however, backplane 30 may be located in any appropriate location within housing 20. Although FIGS. 1A and 1B illustrates for purposes of example a single backplane 30, alternative embodiments of system 10 may include any appropriate number of separate backplanes 30 or interconnected backplanes 30.

Circuit card 40 is a substrate including electronic circuitry and/or computer hardware operable to perform computing functions. In particular embodiments, circuit card 40 is inserted into housing 20 and connects to backplane 30. Circuit card 40 may represent, in whole or in part, a server, router, Ethernet switch, telecommunications switch, firewall, proxy server, content filter, and/or other suitable component. In general, however, circuit card 40 may represent any combination of hardware and/or software suitable to perform electronic operations in system 10. Additionally, although system 10 is illustrated in FIGS. 1A and 1B as including a particular number of circuit cards 40, alternative embodiments of system 10 may include any number, type, or combination of circuit cards 40.

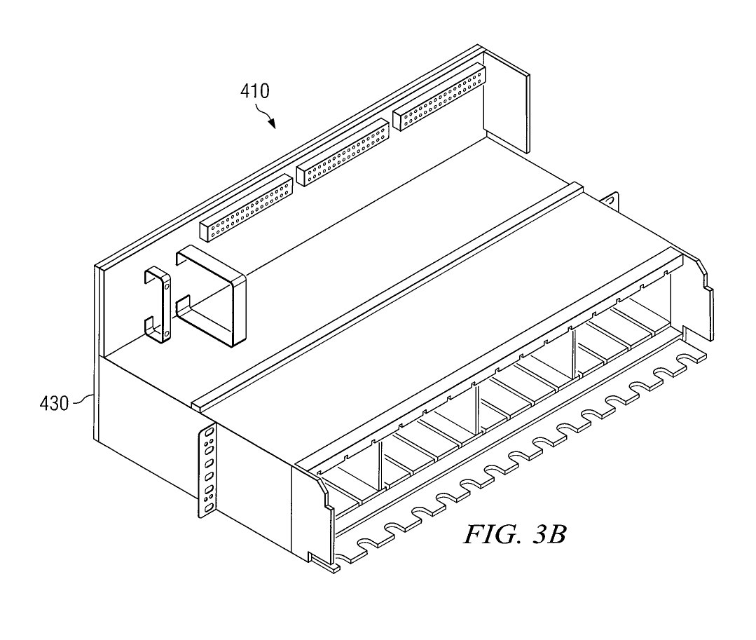

Backplane interfaces 32 and midplane interfaces 34 each comprise electrical hardware positioned in or on backplane 30 and capable of accepting circuit cards 40 and I/O panels 50, respectively. Backplane interfaces 32 and midplane interfaces 34 each include one or more pins, contacts, or other conductive elements (generically referred to here as “connectors”) by which components may form an electrical connection to backplane 30. In particular embodiments, the inclusion of midplane interfaces 34 on opposite sides of backplane 30 from backplane interfaces 32 may allow oversized components to connect to backplane 30 without reducing the number of circuit cards 40 that can also connect to backplane 30 or may allow components having different connection types to connect to a standardized backplane 30. In particular embodiments, midplane interfaces 34 may be mounted on the rear exterior surface of backplane 30. In general, however, midplane interfaces 34 may be attached to any appropriate location within or on housing 20 suitable to perform the described functions. For example, FIGS. 3A and 3B illustrate an alternative embodiment of system 10 that includes a backplane on which I/O panels connect to midplane interfaces that are located on the same side of the backplane as backplane interfaces.

I/O panel 50 is a substrate including electronic circuitry and/or computer hardware operable to perform computing functions, and inserted into a midplane interface 34. In particular embodiments, I/O panel 50 may include a plurality of interfaces to facilitate the input and/or output of information and facilitates the attachment of the physical media. In particular embodiments, I/O panel 50 provides Digital Signal 1 (DS1), Digital Signal 3 (DS3), and local area network (LAN) physical media attachments. I/O panel 50 may represent a printed circuit board that includes interfaces for connecting to an Internet Protocol (IP) based network, a circuit-switched telecommunications network, a power source, a management station, or any other appropriate network or device. For example, in a particular embodiment, I/O panel 50 includes two CHAMP connectors for high density DS1 cables as well as four coaxial connectors to support two DS3 interfaces, with two DS3 cables per interface. Additionally, I/O panel 50 includes connectors configured to allow I/O panel 50 to be inserted into and/or couple to midplane interface 34. In particular embodiments, I/O panel 50 includes connectors for physical media such as DS1, DS3, and LAN connectors on one side and connectors suitable for coupling to backplane 30 on another side.

Although illustrated in FIGS. 1A and 1B as including a single I/O panel 50, system 10 may include any number, type, or combination of I/O panels 50. Additionally, in particular embodiments, I/O panel 50 may extend beyond or be external to housing 20. Each I/O panel 50 may be associated with a specific circuit card or cards 40, and backplane 30 may be configured to couple a particular I/O panel 50 to its associated circuit card(s) 40. For example, in particular embodiments, each I/O panel 50 may be associated with four circuit cards 40, and backplane 30 may couple each midplane interface 34 to four corresponding backplane interfaces 32.

During assembly or at any appropriate time, circuit cards 40 may be inserted into backplane interfaces 32 and coupled to backplane 30. Additionally, I/O panels 50 may be inserted into midplane interfaces 34 and also coupled to backplane 30. Wiring in backplane 30 may then provide electrical connectivity between backplane interfaces 32 and midplane interfaces 34. As a result, once assembled, one or more electrical connections are created between circuit cards 40 and I/O panels 50 through backplane interfaces 32 and midplane interfaces 34 and/or any appropriate collection of other components. In particular embodiments, these electrical connections may include connections for a plurality of differential signal pairs, with each of the pairs including a positive polarity signal and a negative polarity signal. Additionally, backplane 30 may be wired so that the polarity of alternating differential signals are reversed as the differential signals propagate through backplane 30. As a result, backplane 30 may output differential signals at connectors of midplane interface 34, with neighboring differential signals having opposite polarities. Because the polarity of neighboring signals are reversed, these differential signals may produce substantially equal and opposite far-end crosstalk components that cancel one another. Specifically, the far-end crosstalk induced in circuit board connector 32 is cancelled by essentially equal and opposite far-end crosstalk induced in connector 34, due to the polarity reversals

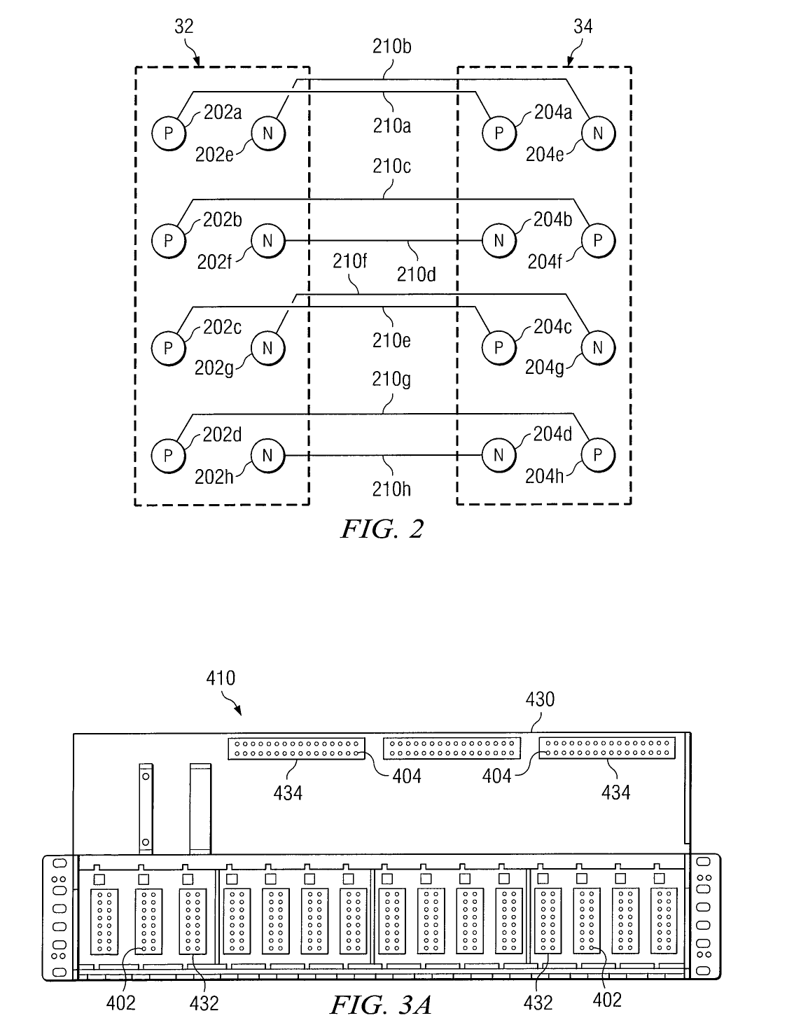

Thus, by configuring the backplane wiring connecting backplane interfaces 32 and midplane interfaces 34 in an appropriate manner, particular embodiments of system 10 may reduce far-end crosstalk for pairs of differential signals transmitted over backplane 30, as described in further detail below with respect to FIG. 2. Additionally, particular embodiments of system 10 may also reduce or eliminate near-end cross talk. In particular embodiments, these benefits may be achieved without the use of expensive adapters to connect components to backplane 30. As a result, particular embodiments of system 10 may provide numerous benefits. Specific embodiments may provide all, some, or none of these benefits however.

FIG. 2 illustrates an example connector configuration for backplane interface 32 and midplane interface 34 and example backplane wiring for a particular embodiment of system 10. Specifically, FIG. 2 shows an example embodiment of backplane 30 in which connectors 202 of backplane interface 32 are connected by a plurality of conductive paths 210 to connectors 204 of midplane interface 34.

Conductive paths 210 each couple a particular connector 202 of backplane interface 32 to a particular connector 204 of midplane interface 34 through the body of backplane 30. Conductive paths 210 may represent wires, leads, metal traces, or any other suitable elements capable of propagating signals between the coupled connectors 202 and 204. In particular embodiments, conductive paths 210 may represent a portion of a bus that couples connectors on a plurality of different backplane interfaces 32 and/or midplane interfaces 34 to one another.

In particular embodiments, conductive paths 210 are configured so that connectors 202 in a first column on backplane interface 32 are connected to an alternating pattern of connectors 204 in a first and second column on midplane interface 34. For purposes of simplicity, a collection of connectors arranged in a substantially linear fashion will be referred to in this description and the claims that follow as a “column” regardless of the orientation of the connectors relative to one another.

For example, in the illustrated embodiment, conductive paths 210 couple connectors 202 in a first column on backplane interface 32 (shown as connectors 202a-d in FIG. 2) to an alternating pattern of connectors 204 in a first column and second column on midplane interface 34 (shown as connectors 204a-d and 204e-h, respectively, in FIG. 2). Similarly, conductive paths 210 couple connectors 202 in a second column on backplane interface 32 (shown as connectors 202e-h in FIG. 2) to an alternating pattern of connectors 204 in the second column and the first column on midplane interface 34. In particular, conductive path 210a couples connector 202a in the first column on backplane interface 32 to connector 204a in the first column on midplane interface 34 and conductive path 210b couples connector 202e in the second column on backplane interface 32 to connector 204e in the second column on midplane interface 34. Meanwhile, connector 202b from the first column of backplane interface 32 is connected to connector 204f in the second column of midplane interface 34, and connector 202f from the second column of backplane interface 32 is connected to connector 204b from the first column of midplane interface 34. This alternating pattern of connections is repeated for the remaining connectors 202 and connectors 204. Consequently, connectors 202 in the first column of backplane interface 32 couple to an alternating pattern of connectors 204 in the first and second columns of midplane interface 34, while connectors 202 in the second column of backplane interface 32 couple to an alternating pattern of connectors 204 in the second and first column of midplane 24, as shown in FIG. 2.

As a result of this backplane wiring, when differential signal pairs are applied to corresponding pairs of connectors 202 in the first column and second column of backplane interface 32 the signals pairs are received at I/O panel 50 with the polarity of every other pair reversed, as shown by the positive (“P”) and negative (“N”) polarity markings in FIG. 2.

Because of the alternating polarity that results in adjacent differential signal pairs, this example configuration of conductive paths 210 may reduce far-end crosstalk on differential signal pairs transmitted over backplane 30. Reduction of far-end crosstalk may allow a user to utilize the full bandwidth capacity of components connected by backplane 30, without sacrificing the modularity, flexibility, and extensibility provided by a backplane configuration. Additionally, in particular embodiments, system 10 may provide reductions in far-end crosstalk without the need for expensive shielded connectors. Particular embodiments of system 10 may also provide for substantial reduction or elimination of near-end crosstalk. As a result, system 10 may provide numerous operational benefits. Specific embodiments of system 10, however, may provide some, none, or all of these benefits.

FIGS. 3A and 3B are a front and perspective view, respectively, of an alternative embodiment of system 10 (referred to here as “system 410”) in which a backplane 430 includes a backplane interface 432 and a midplane interface 434 on the same surface of backplane 430. As noted above, midplane interfaces and backplane interfaces may be arranged in any appropriate manner on the backplane in various embodiments of the described system including on opposite sides of the backplane (as illustrated in FIGS. 1A and 1B) or on the same side of the backplane (as shown in FIGS. 3A and 3B).

As described above with respect to backplane 30 of system 10, backplane 430 includes conductive paths (not shown) that couple a first column of connectors 402 on each backplane interface 432 to an alternating pattern of connectors 404 in a first column and a second column on midplane interface 434. Backplane 430 also includes conductive paths that couple a second column of connectors 402 on each backplane interface 432 to an alternating pattern of connectors 404 in the second column and the first column on midplane interface 434. As a result, backplane 430 of system 410 may, like backplane 30 of FIGS. 1A and 1B, also reduce far-end crosstalk when used to connect circuit cards 40 and I/O panels 50.

Although the present invention has been described with several embodiments, numerous changes, variations, alterations, transformations, and modifications may be suggested to one skilled in the art, and it is intended that the present invention encompass such changes, variations, alterations, transformations, and modifications as fall within the scope of the appended claims. For example, although the description above focuses on various embodiments of a backplane that are configured to accept circuit cards and I/O panels, alternate embodiments may be configured to accept any appropriate electrical components.

1. An electrical system, comprising:
a backplane comprising:
a first column of connectors;
a second column of connectors;
a third column of connectors;
a fourth column of connectors;
a first plurality of conductive paths coupling the connectors in the first column to an alternating sequence of connectors in the third column and the fourth column; and
a second plurality of conductive paths coupling the connectors in the second column to an alternating sequence of connectors in the fourth column and the third column;
a first electrical component coupled to the backplane through the first column of connectors and the second column of connectors; and
a second electrical component coupled to the backplane through the third column of connectors and the fourth column of connectors.

2. The system of claim 1, wherein the first electrical component is operable to transmit a plurality of differential signals to the second electrical component over the first plurality of conductive paths and the second plurality of conductive paths.

3. The system of claim 2, wherein the second electrical component receives the differential signals from the backplane across the third column and the fourth column, with differential signals received over neighboring pairs of connectors having opposite polarities.

4. The system of claim 1, wherein the first electrical component comprises a circuit card.

5. The system of claim 1, further comprising a housing enclosing at least a portion of the backplane and one of the first component and the second component.

6. The system of claim 1, wherein:
the first column and the second column are located on a first side of the backplane; and
the third column and the fourth column are located on a second side of the backplane.

7. The system of claim 1, wherein the first column, the second column, the third column, and the fourth column are located on a single side of the backplane.

8. An apparatus for coupling electrical components, comprising:
a backplane interface comprising:
a first column of connectors; and
a second column of connectors;
a midplane interface comprising:
a third column of connectors; and
a fourth column of connectors;
a first plurality of conductive paths coupling the connectors in the first column to an alternating sequence of connectors in the third column and the fourth column; and
a second plurality of conductive paths coupling the connectors in the second column to an alternating sequence of connectors in the fourth column and the third column.

9. The apparatus of claim 8, wherein the apparatus is operable to receive a plurality of differential signals through the backplane interface, with differential signals received over neighboring pairs of connectors having a same polarity.

10. The apparatus of claim 9, wherein the apparatus is operable to output a plurality of differential signals through the midplane interface, with differential signals output across neighboring pairs of connectors having opposite polarities.

11. The apparatus of claim 8, wherein the apparatus is operable to couple to a circuit card through the backplane interface.

12. The apparatus of claim 8, further comprising a housing enclosing at least a portion of a substrate on which the backplane interface and the midplane interface are located.

13. (canceled)

14. (canceled)
